(19) United States
(12) Patent Application Publication
(10) Pub. No.: US 2016/0279784 A1
(43) Pub. Date: Sep. 29, 2016

(54) FINGER RATCHET TOOL

(71) Applicant: Yao-Lin Cho, Taichung City (TW)

(72) Inventor: Yao-Lin Cho, Taichung City (TW)

(21) Appl. No.: 14/666,292

(22) Filed: Mar. 23, 2015

(51) Int. Cl. B25G 1/04; B25G 1/10; B25B 23/16

(52) U.S. Cl. CPC B25G 1/043; B25B 23/16; B25G 1/107

(57) ABSTRACT

A finger ratchet tool includes a body having a top part on the top thereof, and a ratchet device connected to the underside of the body. Two flanges extend radially from the top part. A connection portion extends from the body. A mounting member has a C-shaped collar which has an opening, and a rod is connected between two ends of the opening. A matching face is defined in the inner periphery of the C-shaped collar. Two recesses are defined in the inner periphery of the C-shaped collar and each have two ends. The rod is pivotably connected to the connection portion, and the C-shaped collar is mounted to the top part. The flanges are engaged with the recesses. The mounting member provides a larger diameter when grasping the finger ratchet tool.

### BACKGROUND OF THE INVENTION

1. Fields of the invention

The present invention relates to a finger ratchet tool, and more particularly, to a finger ratchet tool cooperated with a mounting member which is mounted to the outer periphery of the body so as to provide comfortable grasp feature.

2. Descriptions of Related Art

The conventional finger ratchet tool generally includes a small body with a ratchet device connected thereto, and a bit is removably connected to the body so as to drive the bit. The conventional finger ratchet tool generally is a round tool so that the user holds the finger ratchet tool and rotates it to output torque. However, the diameter of the conventional finger ratchet tool is limited so that the user has to apply a significant force to rotate it. The small body usually makes the user feel uncomfortable after being used for a period of time.

The present invention intends to provide a finger ratchet tool to eliminate the shortcomings mentioned above.

### SUMMARY OF THE INVENTION

The present invention relates to a finger ratchet tool and comprises a body having a top part protruding from the top thereof. A ratchet device is connected to the underside of the body. The top part has a curved face defined in the periphery thereof. Two flanges extend radially from the lower portion of the curved face. A connection portion extends from the body and has a passage defined transversely therethrough. A mounting member has a C-shaped collar which has an opening, and a rod is connected between two ends of the opening. A matching face is defined in the inner periphery of the C-shaped collar. A space is formed within the C-shaped collar. Two recesses are defined in the inner periphery of the C-shaped collar and each have two ends. Multiple grip protrusions are formed on the outer periphery of the C-shaped collar. The rod is engaged with the passage to pivotably connect the C-shaped collar to the body. The C-shaped collar is mounted to the top part of the body, and the matching face is matched with the curved face. The flanges 112 are engaged with the recesses and each are located between the two ends of the recess corresponding thereto.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the finger ratchet tool of the present invention;

FIG. 2 is an exploded view of the finger ratchet tool of the present invention;

FIG. 3A shows that the C-shaped collar is to be pivotably connected to the body;

FIG. 3B shows that the C-shaped collar is pivotably connected to the body;

FIG. 4 is a cross sectional view, taken along line IV-IV in FIG. 3B, and

FIG. 5 shows another perspective view to show that the C-shaped collar is pivotably connected to the body.

### DETAILED DESCRIPTION OF THE PREFERRED EMBODIMENT

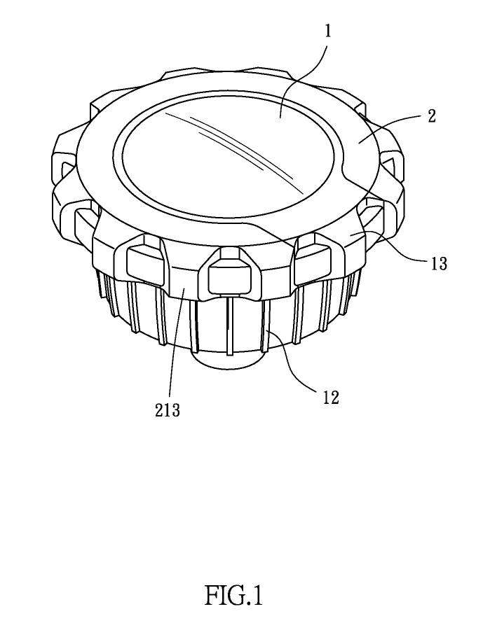

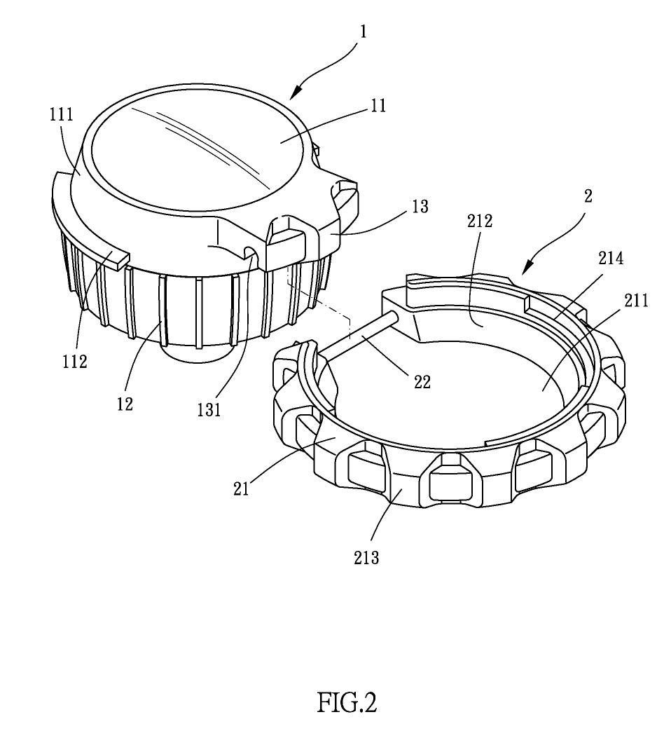

Referring to FIGS. 1 to 2, the finger ratchet tool of the present invention comprises a body 1 having a top part 11 protruding from the top thereof. A ratchet device 12 is connected to the underside of the body 1 and has a connection part for being connected with a bit, for example. The top part 11 has a curved face 111 defined in the periphery thereof. Two flanges 112 extend radially from the lower portion of the curved face 111. A connection portion 13 extends from the body 1 and has a passage 131 defined transversely therethrough. The passage 131 opens through the underside of the connection portion.

A mounting member 2 comprises a C-shaped collar 21 which has an opening, and a rod 22 is connected between two ends of the opening. A matching face 212 is defined in the inner periphery of the C-shaped collar 21. A space 211 is formed within the C-shaped collar 21. Two recesses 214 are defined in the inner periphery of the C-shaped collar 21 and each have two ends. Multiple grip protrusions 213 are formed on the outer periphery of the C-shaped collar 21.

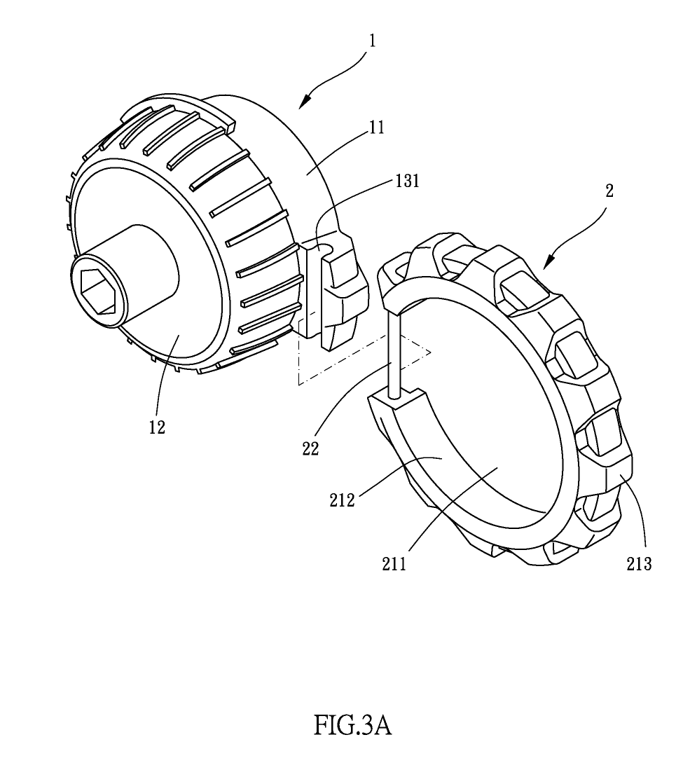

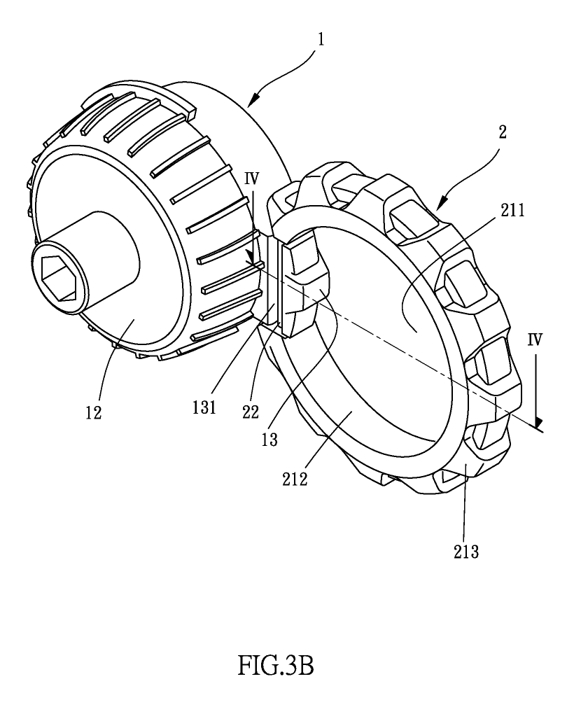

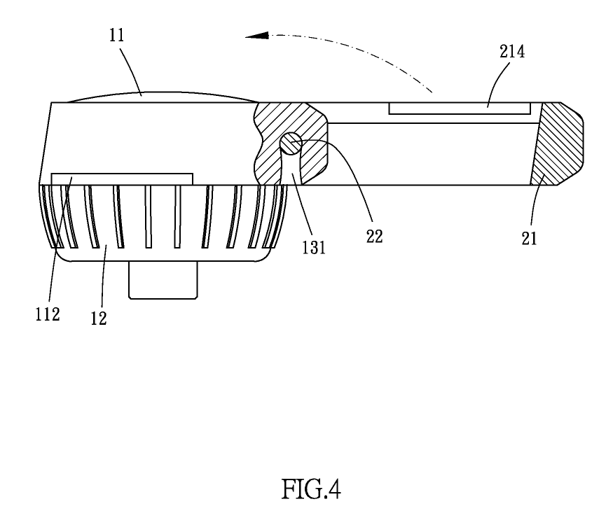

As shown in FIGS. 3A, 3B, 4 and 5, when in use, the rod 22 is engaged with the passage 131 from the underside of the connection portion 13 to pivotably connect the C-shaped collar 21 to the body 1. The C-shaped collar 21 is then pivoted about the rod 22 and mounted to the top part 11 which is accommodated in the space 122 of the C-shaped collar 21. The matching face 212 is matched with the curved face 111 so as to increase the contact area and to provide a larger area in the direction when the finger ratchet tool is pressed downward. The two flanges 112 are respectively engaged with the two recess 214. Each flange 112 is located between the two ends of the recess 214 corresponding thereto.

The user can easily grasp the C-shaped collar 21 by the grasp protrusions 213 so as to firmly operate the finger ratchet tool. Each of the flanges 112 is stopped by the two ends of each of the recesses 214 so that when rotating the C-shaped collar 21, the C-shaped collar 21 drives the body 1. The matching face 212 is matched with the curved face 111 so as to provide a larger area in the direction when the finger ratchet tool is pressed downward.

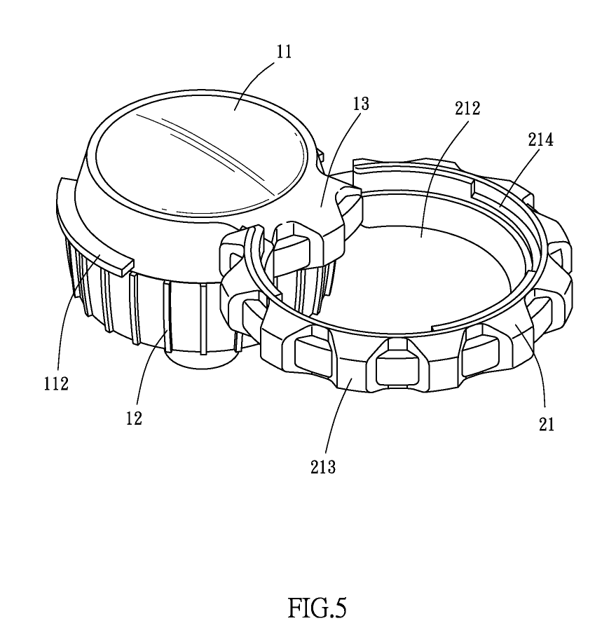

As shown in FIG. 5, when the user wants to obtain a longer arm to rotate the finger ratchet tool, he/she can pivot the C-shaped collar 21 away from the body 1, and use the C-shaped collar 21 as a handle without extra part added.

While we have shown and described the embodiment in accordance with the present invention, it should be clear to those skilled in the art that further embodiments may be made without departing from the scope of the present invention.

What is claimed is:

1. A finger ratchet tool comprising:
a body having a top part protruding from a top thereof, a ratchet device connected to an underside of the body, the top part having a curved face defined in a periphery thereof, at least one flange extending radially from a lower portion of the curved face, a connection portion extending from the body and having a passage defined transversely therethrough, and
a mounting member having a C-shaped collar which has an opening, a rod connected between two ends of the opening, a matching face defined in an inner periphery of the C-shaped collar, a space formed within the C-shaped collar, at least one recess defined in the inner periphery of the C-shaped collar and having two ends, multiple grip protrusions formed on an outer periphery of the C-shaped collar, the rod engaged with the passage, the C-shaped collar mounted to the top part of the body, the matching face matched with the curved face, the at least one flange engaged with the at least one recess and located between the two ends of the at least one recess.
